(19) United States
(12) Patent Application Publication
(10) Pub. No.: US 2017/0053752 A1
(43) Pub. Date: Feb. 23, 2017

(54) LOW FOAMING CARBON ACTIVATION METHOD AND ENERGY STORAGE DEVICE THEREOF

(71) Applicant: Corning Incorporated, Corning, NY (US)

(72) Inventors: Kishor Purushottam Gadkaree, Painted Post, NY (US); Jia Liu, Painted Post, NY (US)

(21) Appl. No.: 15/229,193

(22) Filed: Aug. 5, 2016

Related U.S. Application Data
(60) Provisional application No. 62/206,052, filed on Aug. 17, 2015.

(51) Int. Cl. H01G 11/84; C01B 31/14; C01B 31/12

(52) U.S. Cl. CPC H01G 11/84; C01B 31/125; C01B 31/14

(57) ABSTRACT

A method of making activated carbon including:
drying a carbon source having a volatile organic compound (VOC) content of 10 to 30 wt %, as defined herein; and
milling the resulting dried carbon source to a powder. The method can further include a first heating of the resulting milled powder at from 200 to 450° C., for from 10 mins to 24 hrs. The method can further include making a mixture of the resulting first heated milled powder and an alkali metal hydroxide, and accomplishing a second heating of the milled powder and alkali metal hydroxide mixture, as defined herein.

This application claims the benefit of priority under 35 U.S.C. §119 of U.S. Provisional Application Ser. No. 62/206,052 filed on Aug. 17, 2015 the content of which is relied upon and incorporated herein by reference in its entirety.

### CROSS-REFERENCE TO RELATED CO-PENDING APPLICATIONS

The present application is related to commonly owned and assigned U.S. Application Serial Nos. USSN Application Ser. No. 61/894,990 filed on Oct. 24, 2013, and U.S. Application Ser. No. 61/858,902 filed on Jul. 26, 2013, entitled CARBON FOR HIGH VOLTAGE EDLCS”, now U.S. Pat. No. 9,136,064, which mentions: a method of forming activated carbon, comprising: carbonizing a carbon precursor by heating the carbon precursor at a carbonization temperature effective to form a carbon material; and activating the carbon material by heating the carbon material at an activation temperature while exposing the carbon material to carbon dioxide, wherein the carbon precursor comprises phenolic Novolac resin, but does not claim priority thereto.

The entire disclosure of each publication or patent document mentioned herein is incorporated by reference.

### BACKGROUND

The disclosure generally relates to the field of energy storage devices.

### SUMMARY

In embodiments, the disclosure provides a low foaming method of making activated carbon, which method provides improved efficiency and cost benefits.

### BRIEF DESCRIPTION OF THE DRAWINGS

In embodiments of the disclosure:

FIG. 1 is a TGA-DSC of the dried green coke powder of Example 1.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments of the claimed invention.

In embodiments, the disclosed method of making and using provide one or more advantageous features or aspects, including for example as discussed below. Features or aspects recited in any of the claims are generally applicable to all facets of the invention. Any recited single or multiple feature or aspect in any one claim can be combined or permuted with any other recited feature or aspect in any other claim or claims.

### Definitions

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, refers to variation in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture.

“Optional” or “optionally” means that the subsequently described event or circumstance can or cannot occur, and that the description includes instances where the event or circumstance occurs and instances where it does not.

The indefinite article “a” or “an” and its corresponding definite article “the” as used herein means at least one, or one or more, unless specified otherwise.

Abbreviations, which are well known to one of ordinary skill in the art, may be used (e.g., “h” or “hrs” for hour or hours, “g” or “gm” for gram(s), “mL” for milliliters, and “rt” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The articles and methods of the disclosure can include any value or any combination of the values, specific values, more specific values, and preferred values described herein, including explicit or implicit intermediate values and ranges.

Alkali activation offers the unique ability to control the pore size distribution of the activated carbon product in the micropore size range (i.e., pores smaller than 2 nm). Such alkali activated carbon has significantly higher capacitance than steam activated carbons, which are dominant commercially. However, the cost of alkali activation is traditionally much higher than that of steam activation for a number of reasons, including vaporization of alkali metal, corrosion to furnace and crucibles, safety, etc. Due to these concerns, the furnace needs to be designed to handle these factors and hence, is expensive. It is desirable to maximize the throughput in the activation furnace to lower process cost.

Typically, alkali activation involves: mixing a powder of a carbonaceous raw material and one or more alkali compounds (e.g., KOH, NaOH, K₂CO₃, Na₂CO₃, etc.); loading the mixture in a crucible; and heating the crucible in a furnace. During the heating cycle, the alkali compound(s) melt and react with carbon material to release gases, with water and hydrogen being the main species. As the gas bubbles evolve from the molten material batch, significant volume expansion and foaming can occur, to limiting the amount of material that can be loaded in the crucible and in turn the furnace throughput. For instance, only 20 to 30% of material can be loaded in a crucible by volume. If the amount of volume expansion and foaming can be reduced, then more material can be loaded in a given crucible and the furnace throughput can be improved.

Commonly owned and assigned WO2015/017200 (PCT/US2014/047728), mentions a method to address the foam issue. Fats, oils, fatty acids, or fatty acid esters are used as an additive in the alkali, carbon reaction mixture to minimize foaming. When these additives react with the alkali they can produce alcohol and/or water by-products. These by-products can be undesirable because they can lead to increased potassium metal vapor generation.

Commonly owned and assigned U.S. Ser. No. 14/832,128 mentions a method of making activated carbon including:

compressing a mixture of an alkali metal hydroxide, a carbon source, and a solid thermosetting polymer precursor into a pellet; and

a first heating of the compressed mixture; and

optionally crushing, washing, or both, the resulting first heated mixture, and

optionally a second heating.

In embodiments, the present disclosure provides a different method, where volume expansion and foaming are significantly reduced by controlling the composition of the carbon source material or carbon raw material, specifically, the content of volatile organic compounds (VOCs).

A carbon raw material or carbon source material used for activation is typically prepared by heat-treating a carbon-containing material at an elevated temperature to “carbonize” the material. In most instances, the carbonization temperature is not well controlled. In embodiments, the present disclosure demonstrates that careful control of the carbonization temperature provides control over the VOC content in the carbonized material, which in turn has a significant impact on the amount of expansion/foaming. The resulting activated carbon properties are also greatly influenced.

In embodiments, the disclosure provides a method of making activated carbon comprising:

drying a carbon source having a volatile organic compound (VOC) content of 10 to 30 wt %, at from 100 to 200° C. for from 10 mins to 24 hrs in an inert atmosphere; and

milling the resulting dried carbon source to a powder.

In embodiments, the method can further comprise, for example, a first heating of the resulting milled powder at from 200 to 450° C., for from 10 mins to 24 hours, in an inert atmosphere.

In embodiments, the method can further comprise, for example, making a mixture of the resulting first heated milled powder and an alkali metal hydroxide, and a second heating of the mixture at from 600 to 1,000° C.

In embodiments, the first heating results in a carbon having a VOC content of from 10 to 20 wt %.

In embodiments, the first heating is accomplished in an container open to an external atmosphere, and the second heating is accomplished in a container having a vent.

In embodiments, the alkali metal hydroxide can be, for example, powdered KOH, and the carbon source can be, for example, powdered green coke.

In embodiments, the alkali metal hydroxide and the carbon source can be, for example, in a weight ratio of from 1:1 to 4:1.

In embodiments, the milled powder has a d50 particle size of from 2 to 300 microns.

In embodiments, the drying, milling, and first heating substantially eliminates expansion and foaming of the mixture during the second heating.

In embodiments, the second heating can be accomplished, for example, in for 10 mins to 6 hrs in a forming gas, in an inert gas, or in a combination thereof.

In embodiments, the disclosure provides a method of making activated carbon, which method provides improved efficiency and cost benefits.

In embodiments, the disclosure provides a method for the economic preparation of alkali activated carbon.

In embodiments, the disclosed carbonization methods are advantaged for at least the following reasons:

The throughput in the activation process can be significantly increased for a given furnace, which can lower process cost.

Unlike previous methods, no additive is necessary to achieve the increased activation throughput, which can save material and processing costs.

The mixing process is further simplified by foregoing an additive, particularly compared to a liquid additive, which liquid additive present a challenge due to clumping when a liquid is mixed with a solid powder.

Cost of the optimized carbonization process can be lowered.

In embodiments, the disclosure provides a method for producing activated carbon via chemical activation.

The disclosed methods are summarized below.

### EXAMPLES

Following examples describe the invention in more detail and in greater particularity.

### Example 1

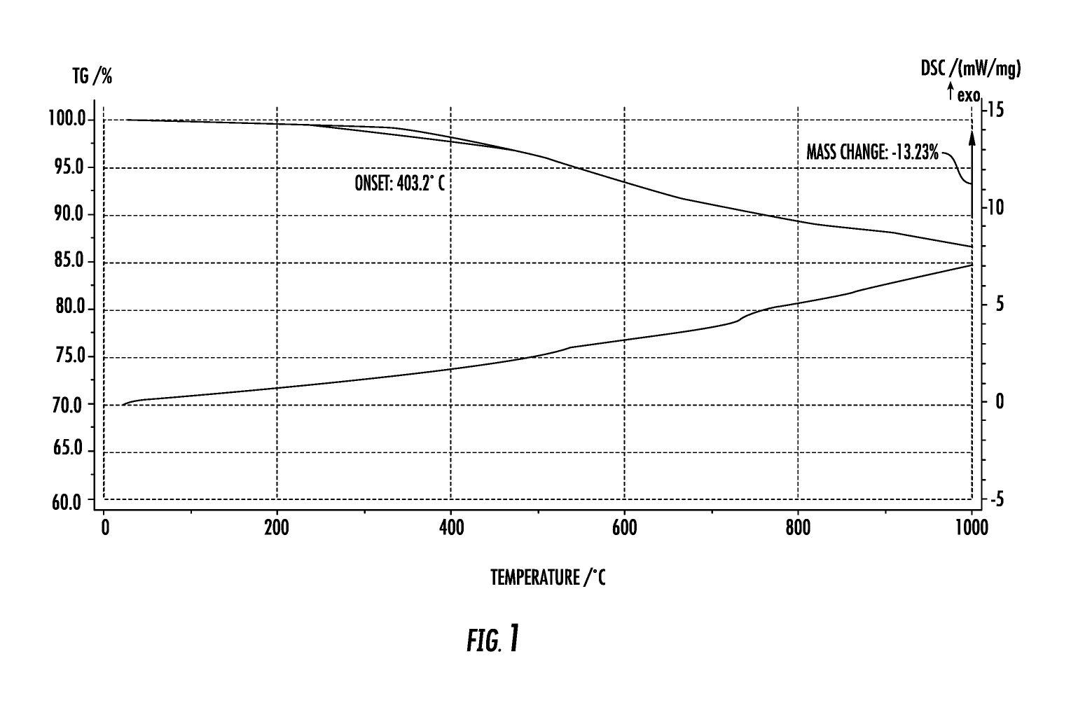

A Rodeo green coke from Conoco Phillips was dried in a retort furnace under N₂ purge at 125° C. for 16 hrs and then milled to a fine powder having a d50 of about 5 microns. A sample of the powder was tested using TGA-DSC as shown in FIG. 1. Note that significant weight loss started to occur while the weight loss at 1000° C. was 13.2%.

Portions of the green coke powder were heat treated for 2 hrs in a retort furnace under N₂ purge at 200° C., 400° C., 500° C., and 600° C., respectively. Based on the TGA data, the weight losses at these temperatures correspond to 0.3%, 1.9%, 3.8%, and 6.6%, respectively. Using the 1000° C. data point as a reference, the volatile organic compound (VOC) content in these four samples was 12.9%, 11.3%, 9.4%, and 6.6%, respectively.

Each of the four heat treated green coke samples and a dried and milled green coke sample (as control) were mixed with a KOH powder (Sigma-Aldrich catalog #06103) at a ratio of 1:2 by weight. Each of the mixed samples was filled into a nickel crucible to about 40% of the volume. Each crucible had a lid having a vent hole in the lid. All five crucibles were loaded in a retort furnace and activated under N₂ purge using the following thermal cycle: ramp at 300° C./hr to 850° C., soak at 850° C. for 2 hours, furnace cool to ambient temperature. Photographic images were taken and the material bed depth in each crucible was measured before and after activation. The control sample and the actual samples (images not shown) that were heat treated at 200° C. and 400° C. showed relatively low levels of volume expansion/foaming. The 500° C. sample showed elevated level of foaming and the material in the crucible actually rose through the vent hole on the lid. The 600° C. sample showed significantly more foaming and the material overflowed from the crucible. This trend can be attributed to the trend in the VOC content in the green coke samples. Additionally, Table 1 below shows the volume expansion of the five samples, where the “average normalized expanded volume after activation” is defined as the average material volume in the crucible after activation divided by the initial material mass before activation. The smaller the average normalized expanded volume, the more material that could be filled in the crucible. The data further supported the trend observed in the pictures.

Sample images were obtained (but not included) for:

a) 200° C. heat treated green coke mixed with KOH in a nickel crucible before activation;

b) All five samples in furnace after activation;

c) The control sample after activation;

d) 200° C. heat treated sample after activation;

e) 400° C. heat treated sample after activation;

f) 500° C. heat treated sample after activation; and

g) 600° C. heat treated sample after activation.

TABLE 1
Average expanded volume after activation in Example 1.

| Green coke pre-heat | Average normalized |
|---|---|
| treatment temperature | expanded volume after |
| (° C.) | activation (cm³/g) |
| Control | 1.7 |
| 200 | 1.8 |
| 400 | 2.1 |
| 500 | Overflow |
| 600 | Overflow |

All activated carbon samples were washed in DI water, 10% HCl, and DI water until pH neutral. Finally, all samples were heat treated in a retort furnace purged with 1% H₂/N₂ at 900° C. for 2 hrs.

Referring again to the Figures, FIG. 1 shows a TGA-DSC graph of the dried green coke powder of Example 1.

The above samples were tested in EDLC cells and the results are summarized in Table 2. It can be seen that both the gravimetric and the volumetric specific capacitance trended lower with increasing pre-heat treatment temperature.

TABLE 2
EDLC cell test results for samples in Example 1

| Green coke pre- | | |
|---|---|---|
| heat treatment | Gravimetric Specific | Volumetric Specific |
| temperature (° C.) | Capacitance (F/g) | Capacitance (F/cm³) |
| Control | 152.0 | 106.3 |
| 200 | 121.3 | 86.1 |
| 400 | 110.5 | 76.7 |
| 500 | 90.6 | 66.5 |
| 600 | 78.7 | 63.6 |

### Comparative Example 2

A char was prepared by carbonizing wheat flour at 800° C. The weight loss was 75.4 wt %. Increasing the carbonization temperature further to 1000° C. resulted in an additional 1% weight loss. Again using the 1000° C. data point as a reference, the VOC content in the char prepared at 800° C. was about 4 wt %.

The char prepared at 800° C. was milled to a fine powder having a d₅₀ of about 5 microns and used in the following experiment. For activation, the char powder was mixed with a KOH powder (Sigma-Aldrich catalog #06103) at a ratio of 1:1.8 by mass. The mixed powder was filled in four different nickel crucibles (without lid) to different levels: A) about 24 vol %; B) about 33 vol %; C) about 41 vol %; and D) about 49 vol %. All four crucibles were loaded into a retort furnace and activated under N₂ purge using the following thermal cycle: ramp at 150° C./hr to 750° C., soak at 750° C. for 2 hrs, furnace cool to ambient temperature. All samples except sample A overflowed due to large amounts of volume expansion/foaming (images not shown).

Based on the above examples, the VOC content in the carbon raw material has a significant effect on volume expansion, foaming, or both, during alkali activation. By controlling the pre-heat treatment conditions, the amount volume expansion, foaming, or both, can be significantly reduced so that more carbon material can be filled into a given crucible and furnace. This increases the throughput without new capital investment and lowers the cost of the activation process, which activation is the most expensive step in alkali activated carbon manufacture. Conversely, too much VOC content is disfavored because the VOCs tend to react with and consume a portion of the KOH so that the KOH ratio may need to be increased to achieve the same level of activation.

The disclosure has been described with reference to various specific embodiments and techniques. However, many variations and modifications are possible while remaining within the scope of the disclosure.

What is claimed is:

1. A method of making activated carbon comprising:
drying a carbon source having a volatile organic compound (VOC) content of 10 to 30 wt %, at from 100 to 200° C. for from 10 mins to 24 hrs in an inert atmosphere; and
milling the resulting dried carbon source to a powder.

2. The method of claim 1 further comprising a first heating of the resulting milled powder at from 200 to 450° C., for from 10 mins to 24 hours, in an inert atmosphere.

3. The method of claim 2 further comprising making a mixture of the resulting first heated milled powder and an alkali metal hydroxide, and a second heating of the milled powder and alkali metal hydroxide mixture at from 600 to 1,000° C.

4. The method of claim 2 wherein the first heating results in a carbon having a VOC content of from 10 to 20 wt %.

5. The method of claim 3 wherein the first heating is accomplished in an container open to an external atmosphere, and the second heating is accomplished in a container having a vent.

6. The method of claim 1 wherein the alkali metal hydroxide is powdered KOH, and the carbon source is powdered green coke.

7. The method of claim 6 wherein the alkali metal hydroxide and the carbon source is in a weight ratio of from 1:1 to 4:1.

8. The method of claim 1 wherein the milled powder has a d50 particle size of from 2 to 300 microns.

9. The method of claim 2 wherein the drying, milling, and first heating substantially eliminates expansion and foaming of the mixture during the second heating.

10. The method of claim 3 wherein the second heating is accomplished in for 10 mins to 6 hrs in a forming gas, in an inert gas, or in a combination thereof.
